(19) United States
(12) Patent Application Publication
(10) Pub. No.: US 2015/0037754 A1
(43) Pub. Date: Feb. 5, 2015

(54) Dental Retraction Cord with Local Anesthetic Agent

(71) Applicant: Ethel Marlene Miles, Fredericksburg, VA (US)

(72) Inventor: Ethel Marlene Miles, Fredericksburg, VA (US)

(21) Appl. No.: 14/450,958

(22) Filed: Aug. 4, 2014

Related U.S. Application Data
(60) Provisional application No. 61/861,499, filed on Aug. 2, 2013.

(51) Int. Cl. A61C 9/00; A61C 19/08

(52) U.S. Cl. CPC A61C 9/0033; A61C 19/08
USPC 433/136

(57) ABSTRACT

A dental retraction cord is used within dental procedures as the dental retraction cord is impregnated with at least one dental anesthetic agent and/or a vasoconstrictor agent so that the dental retraction cord is able to reduce the pain and discomfort during the cord packing process. A plurality of interlocking strands of the dental retraction cord is impregnated with the at least one dental anesthetic agent and/or the vasoconstrictor agent as the dental retraction cord is stored within a container. The at least one dental anesthetic agent and/or the vasoconstrictor agent are activated upon contact with liquid in order to create additional numbness and to reduce loss of blood during the dental procedures.

The current application claims a priority to the U.S. Provisional Patent application Ser. No. 61/861,499 filed on Aug. 2, 2013. The current application is filed on Aug. 4, 2014 while Aug. 2, 2014 was on a weekend.

### FIELD OF THE INVENTION

The present invention relates generally to dental accessories, in particular accessories used in the preparation of dental crowns. More specifically, the present invention is a dental retraction cord impregnated with a low dosage of a short-to-medium term local anesthetic for reducing discomfort and/or pain when retracting gingival tissue in any dental situation, including as part of a crown preparation.

### BACKGROUND OF THE INVENTION

Dental crowns are a form of dental restoration that involves placing a tooth-shaped cap over a tooth. The crown envelops the entire visible portion of the tooth and restores the tooth to its original shape, size, and strength, while also improving the aesthetic appearance of the tooth. Crowns are typically used to restore teeth that have become weak, worn, broken, misshapen, or otherwise compromised. However, crowns can also be utilized in conjunction with other types of dental structures such as implants and bridges. The crown preparation process typically requires a dentist to file and otherwise remove portions of the tooth that is to be crowned. In extreme cases, the dentist may utilize a build-up material such as amalgam, composite, or other core materials to create proper contour and support for the crown. Following preparation of the tooth, the dentist creates an impression of the tooth as well as teeth in the vicinity in order to ensure that the crown seamlessly integrates with the other teeth. In order to create an accurate impression, the gingival tissue surrounding a tooth is temporarily reflected away from the tooth. This is accomplished by “packing” dental retraction cord around the tooth in order to expose the tooth further and allow for more accurate impressions to be made. Because impressions are made towards the end of a tooth preparation procedure, the cord packing process can be slightly uncomfortable to painful as the anesthetic administered prior to the procedure wears off. Many dental patients refuse additional anesthetic towards the end of their procedures as they do not wish to experience residual numbness following the procedure. As a result, the cord packing and impression making processes can be somewhat to very uncomfortable. The present invention seeks to address the aforementioned issues as well as provide a straightforward and convenient solution. On occasion, a patient may not need or refuse local anesthetic, such as in the case of a tooth that has undergone a root canal. However, the gingiva around the tooth is vital and innervated even after a root canal has been performed. The present invention provides sufficient anesthetic to the sensitive portion of the work area and/or in similar situations to keep the patient comfortable without using injected anesthetics.

The present invention is a dental retraction cord that is impregnated with a short-to-medium term local anesthetic to relieve pain during the cord packing process and keep a patient comfortable while the cord remains in the gingival sulcus without causing residual numbness. The cord may remain in the gingival sulcus for a prolonged period of time for a multitude of reasons such as:
1. Multiple impressions may be made: Initial impressions may be discarded by the dentist as unacceptable or inaccurate and a new impression must be made
2.Virtual impressions: Computer-Aided-Design and Computer-Aided-Manufacturing (CAD/CAM) and other digital impression technology have become more prevalent. Until the learning curve and technologies themselves are perfected, digital impression processes may take longer than conventional dental impression processes.
3. Chairside Economical Restoration of Esthetic Ceramics (CEREC) procedures: CEREC procedures allow crowns to be milled on-site, during which a retraction cord may be left in place while the restoration (crown, inlay, onlay, bridge) is being milled. It is best that the gingiva remains retracted for the final cementation of the CEREC milled restoration. Alternatively, the initial cord(s) may be removed to allow new cord(s) to be packed. Milling times may vary from approximately 13 to 22 minutes for single units and longer for bridges. Leaving retraction cord in the gingival sulcus for the duration of the milling process generally requires an additional dose of injected anesthetic.

The present invention comprises a cord that is impregnated with a low dosage of a short-to-medium term local anesthetic such as lidocaine, septocaine, mepivacaine, or a combination thereof. The cord may also be impregnated with epinephrine in order to slow absorption of the anesthetic agent into the gingival tissue. This prolongs the effective duration of the anesthetic agent and lessens or stops the flow of blood in the sulcus as a result of packing the cord as well. As some patients cannot tolerate doses of epinephrine, the present invention may or may not comprise epinephrine. The present invention allows anesthetic to saturate the gingival sulcus during the cord packing process. This reduces general discomfort and pain in the area without requiring an additional full dosage of anesthetic after the initial dosage prior to beginning tooth preparation.

The object of the present invention is to reduce pain and increase comfort for patients during the cord packing process and while the cord remains in the gingival sulcus. The present invention seeks to reduce pain and increase comfort without causing undesired effects such as sloughing of the gingiva. It is a further object of the present invention to not have an unpleasant taste during the cord packing process and also while the cord remains in the sulcus. The present invention is a superior solution to immersing plain dental retraction cord in dental anesthetic prior to the cord packing process. This is due to the fact that dental anesthetic is typically administered by injection and is not pleasant-tasting. It is an even further object of the present invention for the anesthetic to remain non-interfering with the tooth impression process after the cords have been placed and/or removed.

### BRIEF DESCRIPTION OF THE DRAWINGS

FIG. 1 is a perspective view of the dental retraction cord.

FIG. 2 is a schematic cross-section view of the first embodiment of the present invention, showing the at least one dental anesthetic agent and the vasoconstrictor agent.

FIG. 3 is a schematic cross-section view of the second embodiment of the present invention, showing the at least one dental anesthetic agent.

FIG. 4 is a perspective view of the container, showing the stored dental retraction cord within.

### DETAIL DESCRIPTIONS OF THE INVENTION

All illustrations of the drawings are for the purpose of describing selected versions of the present invention and are not intended to limit the scope of the present invention.

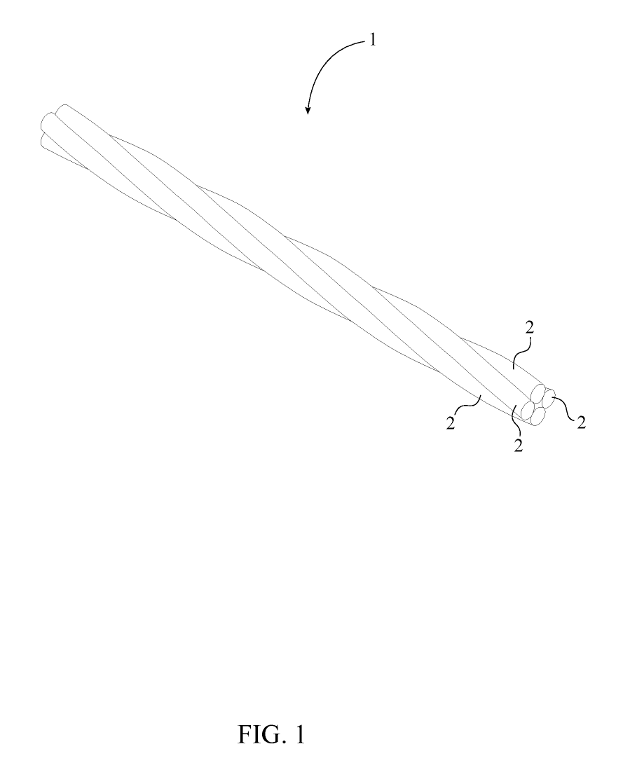

The present invention is a dental retraction cord with local anesthetic agent, where the present invention reduces general discomfort and pain for a patient during the cord packing process of a dental crown, inlay, onlay, bridge, filling, or other dental restoration preparation. In reference to FIG. 1-3, the present invention comprises a dental retraction cord 1 and at least one impregnated agent 3. More specifically, the present invention seeks to provide patients with a means of reducing discomfort and pain during the cord packing process and while the dental retraction cord 1 remains in the gingival sulcus without resulting in residual effects or requiring additional dosages of injected anesthetic during the dental restoration procedures. In reference to FIG. 1, the dental retraction cord 1 is not limited to a specific design as the dental retraction cord 1 comprises a plurality of interlocking strands 2. Each of the plurality of interlocking strands 2 is connected to each along the dental retraction cord 1. For example, the plurality of interlocking strands 2 can be twisted, braided, knitted, or otherwise manipulated in order to form the dental retraction cord 1. The dental retraction cord 1 is not limited with respect to the size and/or thickness of the dental retraction cord 1. However, the size and thickness of the dental retraction cord 1 are determined by the plurality of interlocking strands 2. The dental retraction cords 1 are generally available in a wide variety of sizes including, but not limited to, an extra fine size, a fine size, a small size, a medium size, a large size, and an extra large size.

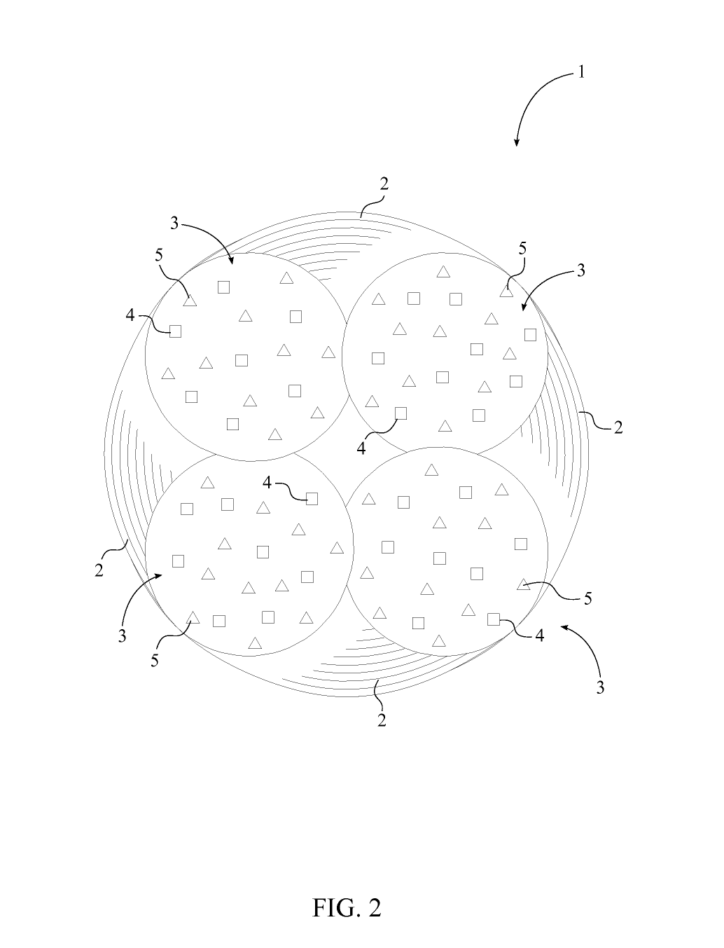

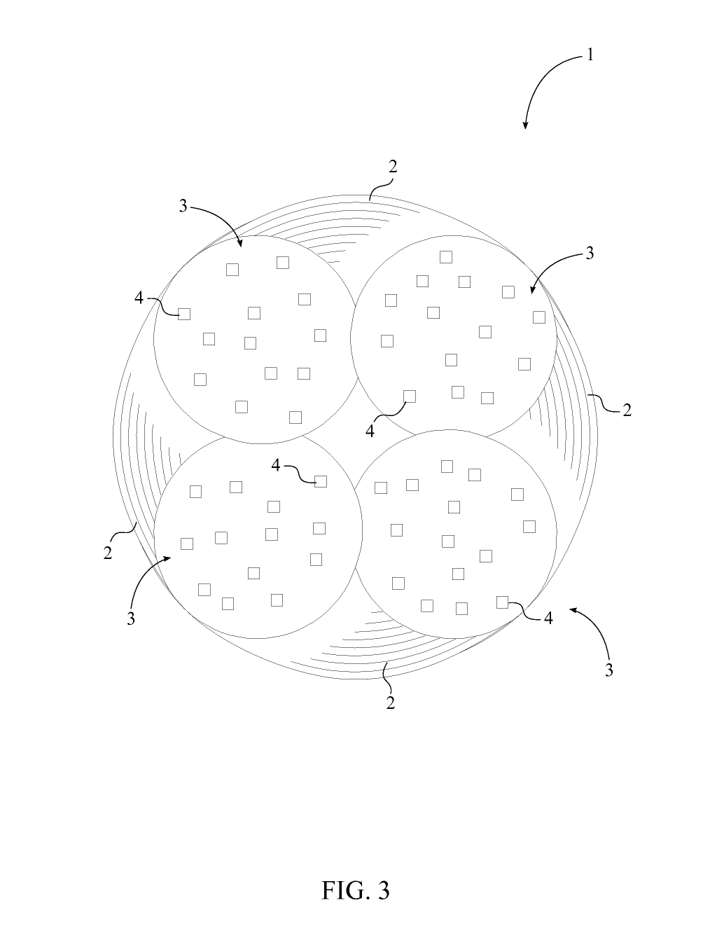

In reference to FIG. 2-3, the at least one impregnated agent 3 comprises at least one dental anesthetic agent 4 in such a way that the dental retraction cord 1 is impregnated with the at least one dental anesthetic agent 4. More specifically, the at least one dental anesthetic agent 4 is impregnated with the plurality of interlocking strands 2 with a low dosage of a short-to-medium term local anesthetic. The present invention is not limited with respect to the specific type of dental anesthetic agent 4 such that various types of dental anesthetic agents 4 may be used including, but are not limited to, lidocaine, septocaine, mepivacaine, or a combination thereof. The at least one dental anesthetic agent 4 is palatable and maintains no taste or a pleasant taste during the cord packing process while the present invention remains in place. The at least one dental anesthetic agent 4 is impregnated within the dental retraction cord 1 and dried for within the present invention. The at least one dental anesthetic agent 4 is activated upon contact of a patient's saliva or other liquid such as distilled water. As a result, the dosage of the at least one dental anesthetic agent 4 is able to reduce the general discomfort and pain of the cord packing process.

In reference to FIG. 2, the at least one impregnated agent 3 further comprises a vasoconstrictor agent 5 as the vasoconstrictor agent 5 is impregnated with the plurality of interlocking strands 2. The present invention preferably uses epinephrine as the vasoconstrictor agent 5. More specifically, the vasoconstrictor agent 5 slows the absorption process of the at least one dental anesthetic agent 4 into the gingival tissue surrounding to the preparation area and prolongs the effective duration of the at least one dental anesthetic agent 4 in order to allow sufficient time for the cord packing process and dental impression procedures to be completed. In addition to prolonging the effective duration of the at least one dental anesthetic agent 4, the vasoconstrictor agent 5 reduces the amount of blood loss during the cord packing process.

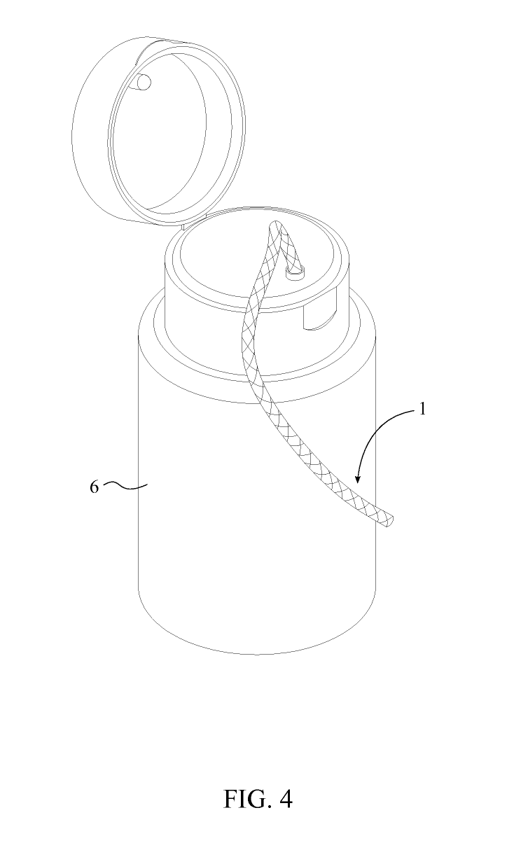

A first embodiment of the present invention is shown in FIG. 1 and FIG. 2, where the dental retraction cord 1 is impregnated with the at least one dental anesthetic agent 4 and the vasoconstrictor agent 5 to provide the ultimate comfort to the patient. As a result, the patient is able to benefit from both the at least one dental anesthetic agent 4 and the vasoconstrictor agent 5 during the dental procedure. Additionally, the first embodiment is stored within a container 6, which is shown in FIG. 4, to protect the effectiveness of the at least one dental anesthetic agent 4 and the vasoconstrictor agent 5 from outside elements prior to the usage.

A second embodiment of the present invention is shown in FIG. 1 and FIG. 3, where the dental retraction cord 1 is only impregnated with the at least one dental anesthetic agent 4 as some patients cannot tolerate the vasoconstrictor agent 5. Therefore, the dental retraction cord 1 with the at least one dental anesthetic agent 4 can be utilized within those patients. Since the vasoconstrictor agent 5 is not present in the dental retraction cord 1, the second embodiment do not utilizes the benefits of the vasoconstrictor agent 5. However, the actions of the vasoconstrictor agent 5 do not negatively effect on the patient's health. Similar to the first embodiment, the second embodiment is also stored within the container 6 to protect the effectiveness of the at least one dental anesthetic agent 4 from outside elements prior to the usage.

It is an object of the present invention to reduce general discomfort and pain for patients during the cord packing process of a dental crown preparation or other dental restorative restoration procedure while the dental retraction cord 1 remains in place. Typically, anesthetic received prior to the commencement of the dental crown preparation procedure begins to wear off around the cord packing process. The present invention provides an additional low dosage of the at least one dental anesthetic agent 4 to compensate for the initial anesthetic wearing off. The short-to-medium term of the at least one dental anesthetic agent 4 provides sufficient numbness of the gingiva surrounding the preparation area without resulting in residual numbness following the procedure. As a result, the present invention provides a superior alternate to injecting a patient with another dosage of local anesthetic as the patient may be left with an unfamiliar and uncomfortable residual numbness after the dental crown preparation procedure has concluded.

Although the invention has been explained in relation to its preferred embodiment, it is to be understood that many other possible modifications and variations can be made without departing from the spirit and scope of the invention as hereinafter claimed.

What is claimed is:

1. A dental retraction cord with local anesthetic agent comprises:
a dental retraction cord;
at least one impregnated agent;
the dental retraction cord comprises a plurality of interlocking strands;
the at least one impregnated agent comprises at least one dental anesthetic agent; and
the dental retraction cord being impregnated with the at least one dental anesthetic agent.

2. The dental retraction cord with local anesthetic agent as claimed in claim 1, wherein each of the plurality of interlocking strands being connected with each other along the dental retraction cord.

3. The dental retraction cord with local anesthetic agent as claimed in claim 1, wherein The at least one dental anesthetic agent being impregnated with the plurality of interlocking strands.

4. The dental retraction cord with local anesthetic agent as claimed in claim 1, wherein each of the plurality of interlocking strands determines the thickness of the dental retraction cord.

5. The dental retraction cord with local anesthetic agent as claimed in claim 1, wherein the at least one dental anesthetic agent comprises agents selected from the group consisting of lidocaine agent, septocaine agent, mepivacaine, and combinations thereof.

6. The dental retraction cord with local anesthetic agent as claimed in claim 1 comprises:
the at least one impregnated agent further comprises a vasoconstrictor agent; and
the vasoconstrictor agent being impregnated with the plurality of interlocking strands.

7. The dental retraction cord with local anesthetic agent as claimed in claim 6 comprises:
the vasoconstrictor agent being epinephrine,
wherein the epinephrine slows absorption and prolong duration of the at least one dental anesthetic agent;
wherein the epinephrine reduces the amount of blood loss.

8. The dental retraction cord with local anesthetic agent as claimed in claim 1, wherein the least one impregnated agent is activated upon contact with liquid.

9. The dental retraction cord with local anesthetic agent as claimed in claim 1, wherein the dental retraction cord being stored within a container prior to usage.

10. A dental retraction cord with local anesthetic agent comprises:
a dental retraction cord;
at least one impregnated agent;
the dental retraction cord comprises a plurality of interlocking strands;
the at least one impregnated agent comprises at least one dental anesthetic agent;
each of the plurality of interlocking strands being connected with each other along the dental retraction cord;
the dental retraction cord being impregnated with the at least one dental anesthetic agent; and
the dental retraction cord being stored within a container prior to usage, wherein the least one impregnated agent is activated upon contact with liquid.

11. The dental retraction cord with local anesthetic agent as claimed in claim 10, wherein The at least one dental anesthetic agent being impregnated with the plurality of interlocking strands.

12. The dental retraction cord with local anesthetic agent as claimed in claim 10, wherein each of the plurality of interlocking strands determines the thickness of the dental retraction cord.

13. The dental retraction cord with local anesthetic agent as claimed in claim 10, wherein the at least one dental anesthetic agent comprises agents selected from the group consisting of lidocaine agent, septocaine agent, mepivacaine, and combinations thereof.

14. The dental retraction cord with local anesthetic agent as claimed in claim 10 comprises:
the at least one impregnated agent further comprises a vasoconstrictor agent; and
the vasoconstrictor agent being impregnated with the plurality of interlocking strands.

15. The dental retraction cord with local anesthetic agent as claimed in claim 14 comprises:
the vasoconstrictor agent being epinephrine,
wherein the epinephrine slows absorption and prolong duration of the at least one dental anesthetic agent;
wherein the epinephrine reduces the amount of blood loss.
